(19) United States
(12) Patent Application Publication
(10) Pub. No.: US 2021/0197653 A1
(43) Pub. Date: Jul. 1, 2021

(54) PROTECTIVE COVER FOR MOVING VEHICLES

(71) Applicant: CONFEZIONI ANDREA ITALIA S.R.L., BODIO LOMNAGO (VA) (IT)

(72) Inventor: Andrea TAVELLI, Bodio Lomnago (VA) (IT)

(73) Assignee: CONFEZIONI ANDREA ITALIA S.R.L., BODIO LOMNAGO (VA) (IT)

(21) Appl. No.: 17/268,617

(22) PCT Filed: Aug. 22, 2019
(86) PCT No.: PCT/IB2019/057080

§ 371 Date: Feb. 16, 2021

(30) Foreign Application Priority Data
Aug. 23, 2018 (IT) 102018000008170

(51) Int. Cl. B60J 11/04

(52) U.S. Cl. CPC B60J 11/04; B32B 27/12

(57) ABSTRACT

A protective cover for vehicle movement that includes: a contact layer including a plurality of fibres made of a hydrophobic material, where the contact layer is arranged to be laid on an external surface of a vehicle; a protection layer including a laminate made of a plastic material engaged on the contact layer; a plurality of welding spots distributed over a surface of the protective cover, according to a predetermined pattern recurring over the surface, the welding spots structurally stabilizing the contact layer and joining the latter to the protection layer. The welding spots are distributed over the surface of the protective cover according to a percentage of welded area not higher than 17% of the total reference surface and the pattern of the welding spots which recurs over the reference total surface of the protective cover defines on the latter a plurality of dampening swellings.

The present invention relates to a protective cover for vehicle movement.

The present invention refers to the industrial sector of protective covers for vehicle movement such as for example cars, vans, lorries, buses, caravans, motorcycles and/or the like.

As it is known, there are various types of protections that can be applied to vehicles during the movement, transportation and storage thereof to protect the external parts that can be damaged by undesired impact with solid bodies such as, for example, stones, gravel, sand, abrasive powders, or atmospheric events of strong intensity such as, for example, hail and all events characterised by high speed wind that can transport small and large debris.

In particular, the object of the present invention concerns protective covers for vehicles, also of the partial type, intended for production industries, dealerships and all industrial and/or commercial businesses that envisage both the movement of vehicles and the parking thereof in stoppage areas provided inside factories or outside.

Among the various covering covers used for protecting vehicles during their movement and/or stoppage in the parking areas, covers composed of fibres are known, made of a hydrophobic material such as for example a polymer and/or copolymer, appropriately interlaced with water, calendered, stabilized by means of microwelding and laminated with suitable materials according to known processes.

Generally, such covering covers have a titration comprised between 3.0 dtex and 3.5 dtex, with a percentage of welded area that can oscillate between 18% and 20% of the total reference area of the protective cover.

With particular reference to the welding percentage of the aforesaid covering covers, the Applicant has found that the distribution of welding points is concentrated to the extent as to give the cover itself an excessively laminar configuration that does not guarantee the optimal protection of the covered vehicles in the event of undesired impacts with stones, gravel, hail and/or any other solid body that intercepts the vehicle during its transportation and/or parking.

The aim of the present invention is to provide a protective cover for vehicle movement, able to solve the problems observed in the known technique.

It is therefore an object of the present invention to provide a protective cover for vehicle movement that with the equivalent basis weight to known covers is thicker and softer.

It is a further object of the present invention to provide a protective cover for vehicle movement which, with the equivalent basis weight to known covers is better able to absorb impacts with stones, gravel, hail and/or any other solid body that intercepts the vehicle during the transportation and/or parking thereof.

It is also an object of the present invention to provide a protective cover for vehicle movement which, with the equivalent basis weight to known covers protects and safeguards the structural integrity and aesthetic finishes of the vehicle on which it is applied, from undesired impact with stones, gravel, hail and/or any other solid body that intercepts the vehicle during the transport and/or parking thereof.

The aim and objects specified above and others, are substantially achieved by a protective cover for vehicle movement, as described and claimed in the following claims.

There is now provided, by way of example, the description of a protective cover for vehicle movement, according to the present invention, in a preferred but not exclusive embodiment.

Such description will be made herein below with reference to the accompanying drawings, provided for indicative purposes only and therefore not limiting, wherein:

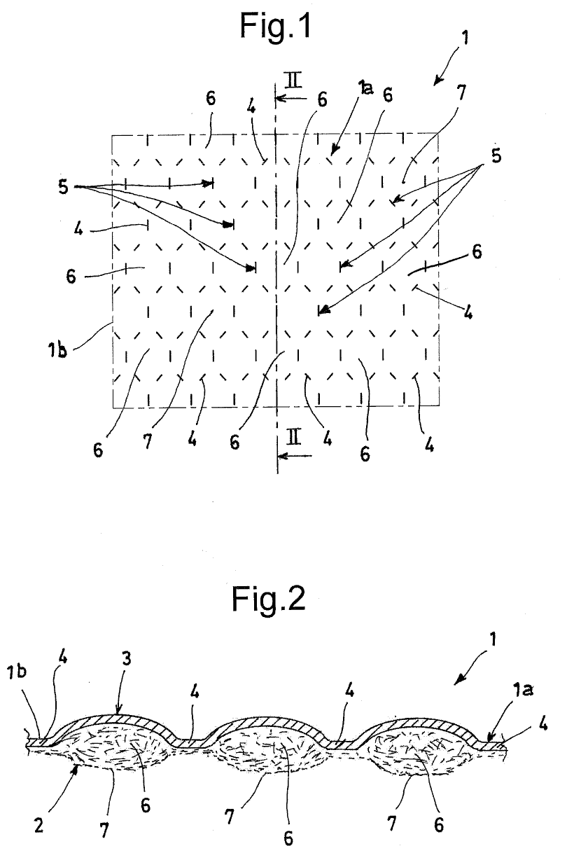

FIG. 1 is a schematic view of a portion of a protective cover for vehicle movement, according to the present invention;

FIG. 2 is a schematic section of the portion of protective cover for vehicle movement, performed along the line II-II of FIG. 1.

With reference to the appended figures, the reference number 1 generally indicates a protective cover for vehicle movement, according to the present invention. As can be seen in the schematic section depicted in FIG. 2, the protective cover 1 comprises a contact layer 2 arranged to be laid on at least an external surface of a respective vehicle to be protected.

The contact layer 2 comprises a plurality of fibres made interlaced with water or needles.

Preferably, the fibres that constitute the contact layer 2 are made of hydrophobic and/or hydrophilic material.

In detail, the fibres of the contact layer 2 are made of a polymer and/or a copolymer.

Advantageously, the fibres that form the contact layer 2 are made of polypropylene.

However, it is not excluded that the contact layer 2 is also formed by fibres made of another suitable material to perform the same task as the polypropylene fibres. According to an alternative embodiment of the present invention, the fibres that constitute the contact layer 2 comprise a core made of a first material, selected from a polymer and/or a copolymer, and an external sheath made of a second material different from the first one and also selected from a polymer and/or a copolymer. Still with reference to the schematic section represented in FIG. 2, the protective cover 1 further comprises a protection layer 3 having at least one laminate that engages the contact layer 2 on the opposite side with respect to the side intended to be laid on the surface of the vehicle to be protected.

Advantageously, the laminate of the protection layer 3 is made of a plastic material, preferably polyethylene. Naturally, the laminate of the protection layer 3 can be made of any other material able to perform the same tasks.

It is for example possible to provide for the protective layer 3 to even be made of polyester and/or polyolefin material.

As can be seen in the appended figures, the protective cover 1 is provided with a plurality of welding spots 4 distributed over a surface 1a or over at least a surface portion 1b of the protective cover 1, according to a predetermined pattern 5 that recurs over the surface 1a of the protective cover itself.

It is to be specified that, in the present description, the term “pattern” means the representation of one or more figures or drawings that are repeated and reproduced various times on the surface 1a of the protective cover 1.

Advantageously, the welding spots 4 structurally stabilize the contact layer 2 and join the latter to the protection layer 3.

The welding spots 4 are obtained by heat sealing and/or ultrasonic welding and/or any other alternative welding technique.

According to an advantageous aspect of the present invention the welding spots 4 are distributed over the surface 1a or over at least a portion 1b of the surface 1a of the protective cover 1 according to a percentage of welded area not higher than 17% of the total reference surface 1a.

Preferably, the welding spots 4 are distributed over the surface 1a or over at least a portion 1b of the surface 1a of the protective cover 1 according to a percentage of welded area not higher than 15% of the total reference surface 1a.

Even more preferably, the welding spots 4 are distributed over the surface 1a or over at least a portion 1b of the surface 1a of the protective cover 1 according to a percentage of welded area not less than 13% of the total reference surface 1a.

In particular, it is preferable that the welding spots 4 are distributed over the surface 1a or over at least a portion 1b of the total reference surface 1a according to a percentage of welded area comprised between 10% and 12% of the total reference surface 1a.

As can be seen in the appended figures, in particular in FIG. 2, the pattern 5 of the welding spots 4 which recurs over the reference total surface 1a of the protective cover 1 defines on the latter a plurality of dampening swellings 6.

Preferably, each dampening swelling 6 is defined by a number of welding spots 4 not lower than five.

According to the embodiment illustrated in FIG. 1, each dampening swelling 6 is defined by six welding spots 4 arranged according to a substantially hexagonal shape. The pattern 5 of the welding spots 4 recurring over the total reference surface 1a of the protective cover 1 defines a substantially polygonal and/or circular and/or elliptical region providing the respective dampening swelling 6 with substantially the same shape.

Naturally, as the number of welding spots that define the dampening swellings 6 changes, also the shape of the latter can change.

It is not excluded that the patterns 5 are comprised of two or more dampening swellings 6 having different shapes from each other.

With particular reference to FIG. 2, each dampening swelling 6 has, in the maximum detectable thickness point 7 (FIGS. 1 and 2) at the furthest point from respective welding spots 4, a thickness comprised between 0.5 mm and 2 mm.

According to a further advantageous aspect of the present invention, the contact layer 2 has a titration comprised between 1.0 dtex and 2.5 dtex, more preferably between 1.4 dtex and 2.4 dtex, even more preferably between 1.8 dtex and 2.3 dtex.

The protective cover 1 described above solves the problems encountered in the prior art and allows important advantages to be obtained.

Above all, the protective cover 1 according to the present invention more effectively protects the external surface of the vehicle to which it is applied with respect to covers of the prior art.

In particular, the presence of a plurality of dampening swellings 6 allows the absorption of impacts of solid bodies, such as stones, gravel, hail and the like that can impact against vehicles during the movement, transportation and/or parking thereof in relevant stoppage areas.

A reduced percentage of welding spots is also to be noted, which allows protective covers to be obtained which, with an equivalent weight to protective covers of the prior art, have a greater thickness, and more marked softness and pliability therefore being more predisposed to mitigate undesired impacts safeguarding the integrity of the external surface of the respective vehicles to be protected.

It is also to be considered that the titration indicated according to the present invention allows a more uniform contact layer of each protective cover to be obtained with respect to known covers.

Therefore, the thicknesses of the protective covers are more regular, allowing greater coverage of the vehicle surfaces to be protected.

It is finally to be noted that the reduced yarn count of the fibres that constitute the contact layer of the covering cover with respect to the yarn count of the fibres of known covers allows a more effective air barrier to be created.

1. A protective cover, comprising:
a contact layer comprising a plurality of fibres made of a material impermeable to at least water, wherein the contact layer is arranged to be laid on at least an external surface of a respective vehicle to be protected;
a protection layer comprising at least a laminate made of a plastic material engaged on the contact layer; and
a plurality of welding spots distributed over a surface or over at least a surface portion of the protective cover, according to a predetermined pattern recurring over the surface, the welding spots structurally stabilizing the contact layer and joining the latter to the protection layer;
wherein:
the welding spots are distributed over the surface or over at least a surface portion of the protective cover according to a percentage of welded area not higher than 17% of the total reference surface of the protective cover;
the pattern of the welding spots which recurs over the total reference surface of the protective cover defines on the latter a plurality of dampening swellings.

2. The protective cover according to claim 1, wherein the percentage of the welded area of the welding spots distributed over the surface or over at least a surface portion of the protective cover is not higher than 15% of the total reference surface.

3. The protective cover according to claim 1, wherein each dampening swelling is defined by a number of welding spots not lower than five.

4. The protective cover according to claim 1, wherein each dampening swelling has, in a maximum detectable thickness point at a furthest point from respective welding spots, a thickness comprised between 0.5 mm and 2 mm.

5. The protective cover according to claim 1, wherein the contact layer has a titration comprised between 1.0 dtex and 2.5 dtex.

6. The protective cover according to claim 1, wherein the welding spots are obtained by heat sealing and/or ultrasonic welding.

7. The protective cover according to claim 1, wherein the contact layer fibres are made of a polymer and/or a copolymer.

8. The protective cover according to claim 1, wherein the contact layer fibres are at least made of polypropylene.

9. The protective cover according to claim 1, wherein the contact layer fibres comprise:
a core made of at least one first material selected from the group consisting of a polymer and a copolymer; and
an external sheath made of at least one second material, which is different from the first material and at least one selected from the group consisting of a polymer and a copolymer.

10. The protective cover according to claim 1, wherein the protective layer is made of a least one selected from the group consisting of a polyester material, a polyethylene material, and a polyolefin material.

11. The protective cover according to claim 1, wherein the pattern of the welding spots recurring over the total reference surface of the protective cover defines a substantially polygonal and/or circular and/or elliptical region providing the respective dampening swelling with substantially the same shape.

12. The protective cover according to claim 1, wherein the percentage of the welded area of the welding spots distributed over the surface or over at least a surface portion of the protective is not higher than 13% of the total reference surface.

13. The protective cover according to claim 1, wherein the percentage of the welded area of the welding spots distributed over the surface or over at least a surface portion of the protective is from 10% to 12% of the total reference surface.

14. The protective cover according to claim 1, wherein the contact layer has a titration comprised between 1.4 dtex and 2.4 dtex.

15. The protective cover according to claim 1, wherein the contact layer has a titration comprised between 1.8 dtex and 2.3 dtex.
